(19) United States
(12) Patent Application Publication
(10) Pub. No.: US 2011/0077342 A1
(43) Pub. Date: Mar. 31, 2011

(54) METHOD FOR THE MULTI-STEP PREPARATION OF HALOGEN-CONTAINING COMPOSITE LATEX HAVING ASSOCIATIVE GROUPS

(75) Inventors: Manuel Hidalgo, Brignais (FR); Thierry Pascal, Charly (FR)

(73) Assignee: ARKEMA FRANCE

(21) Appl. No.: 12/995,768

(22) PCT Filed: May 11, 2009
(86) PCT No.: PCT/FR09/50855

§ 371 Date: Dec. 2, 2010

(30) Foreign Application Priority Data
Jun. 3, 2008 (FR) 0853666

(51) Int. Cl. C08L 13/02; C08L 19/02; C09J 113/02; C09J 119/02

(52) U.S. Cl. 524/460; 524/458

(57) ABSTRACT

“The invention relates to a method for preparing a composite latex, including

(a) a first step of free radical emulsion or microsuspension polymerization or copolymerization, leading to the production of a first polymer latex, and

(b) a second step of free radical microsuspension, emulsion, or suspension polymerization or copolymerization in the presence of the first polymer latex obtained in the first step (a), characterized in that the first polymer forming the latex obtained in step (a) is a halogen-containing vinyl polymer and the polymer formed in step (b) is an associative copolymer, preferably compatible with the halogen-containing vinyl polymer, which contains units from a first monomer (A) and units from a second monomer (B) having at least one associative group; however the nature of both polymers are capable of being reversed. The invention also relates to a latex or polymer suspension obtained by said method and to a polymer composition obtained from the latter, as well as to the use of said latex, from said suspension or said polymer composition, for manufacturing rigid or plasticized materials.”

The present invention relates to a method for preparing a composite latex containing both a halogen-containing vinyl polymer and an associative copolymer, preferably compatible with the latter, said copolymer containing both units from a first acrylic or vinyl monomer (A) and units from a second monomer (B) bearing at least one associative group. The two polymers constituting the latex are prepared during two successive steps of radical polymerization, in a dispersed medium, the second step being applied in the presence of the product from the first step. The present invention also relates to a composite latex or a polymer suspension obtained according to this method, to a polymer composition prepared from said latex or from said suspension and to various uses thereof.

The so-called supramolecular materials are materials consisting of compounds associated together by a plurality of noncovalent bonds, such as hydrogen bonds, ionic bonds and/or hydrophobic interactions. They may in particular be polymers on which associative groups, able to join together by cooperative hydrogen bonds, are grafted. One advantage of these materials is that these noncovalent bonds lead to linkages that are reversible, notably under the effect of temperature or by the action of a selective solvent. The ease of application and/or the properties of the polymers, such as the mechanical, rheological, thermal, optical, chemical, and physicochemical properties, may therefore be improved by the presence of these associative groups. The latter make it possible in particular to endow polymers of low mass, which are generally easy to prepare in a controlled manner, with certain properties of polymers of high mass without the latter's drawbacks such as high viscosity in the molten state.

Thus, document WO 2006/016041 discloses polymers containing grafted associative groups, which endow them with a higher elastic modulus and better resistance to solvents.

Moreover, document U.S. Pat. No. 2,980,652 discloses a product resulting from the reaction of a unit bearing imidazolidone associative groups with a copolymer resulting from the copolymerization of certain monomers with anhydride functions, such as maleic anhydride, itaconic anhydride or citraconic anhydride, with at least one unsaturated ethylene comonomer. It is stated that this product has good adhesion to metals, to glass and to plastics. Example 9 of this document discloses more particularly the product of reaction of 1-(2-aminoethyl)imidazolidin-2-one with a copolymer of maleic anhydride and methyl methacrylate. This product is formulated as a lacquer that can be sprayed onto steel panels (Examples 14 and 15).

In this context, the applicant was interested in means for modifying halogen-containing vinyl polymers such as PVC with a view to making them into supramolecular materials and thus improving their properties. Thus, various tests were undertaken, with the aim of grafting imidazolidone associative groups on PVC by reacting the latter with 1-(2-aminoethyl)imidazolidin-2-one (UDETA).

However, it became clear during these tests that nucleophilic attack of the UDETA on the PVC led to degradation of the latter by dehydrochlorination, with concomitant formation of hydrochloric acid, which made the direct grafting of UDETA in the bulk (without solvent) on PVC impossible in equipment for processing PVC, such as calenders, extruders or presses.

To get round this problem, other routes were envisaged, but they all have major drawbacks.

Thus, solvent grafting allows adjustment of the operating conditions (concentration of PVC and UDETA, choice of solvent, temperature) to promote substitution of PVC with UDETA and prevent its degradation, but it requires large amounts of solvent.

Moreover, although in principle representing an interesting alternative to grafting, the copolymerization of vinyl chloride with methacrylic comonomers bearing associative groups of the imidazolidone type comes up against the large difference between the ratios of reactivity generally found for (meth)acrylic/vinyl chloride monomer pairs (see J. BANDRUP et al., Polymer Handbook, 3rd Edition, John Wiley), resulting, as is known, in copolymers having a very heterogeneous composition of monomers.

Within the scope of its research with the aim of developing new halogen-containing polymer systems with associative groups, the applicant found that it was not necessary to fix said associative groups by covalent bonding on the chlorinated polymer, but that it was sufficient to introduce them indirectly into the halogen-containing polymer by first fixing them on a polymer, called hereinafter associative polymer or associative copolymer, and by incorporating this polymer bearing associative groups in the halogen-containing polymer whose properties we wish to modify.

More precisely, it was demonstrated that the polymer bearing associative groups led to a considerable improvement of the properties of adhesion to metals and creep strength of a halogen-containing vinyl polymer, such as PVC, and could possibly also provide it with interesting rheological, mechanical or thermal properties, in particular higher elongation at break, better thermal stability, a higher softening point and better melt behavior at low shear gradient.

For the modification of the properties of the halogen-containing polymer by incorporation of polymer bearing associative groups to be effective, the two polymers must be mixed intimately with one another and are preferably at least partially compatible with one another.

The present invention relates to an interesting way of obtaining an intimate mixture of two polymers, one being a halogen-containing vinyl polymer and the other a polymer bearing associative groups. According to the present invention, these two polymers are closely associated with one another within particles of latex, through the application of two successive steps of radical polymerization in a dispersed medium.

Moreover, the method of obtaining the intimate mixture of two polymers of the present invention means that the condition of total miscibility between the halogen-containing vinyl polymer and the polymer bearing associative groups, necessary for good mixing in the applicant's previous works, becomes a preferred embodiment in the present invention.

More precisely, the present invention relates to a method for preparing a composite latex comprising

(a) a first step of radical polymerization or copolymerization in emulsion, in microsuspension or in mini-emulsion, resulting in a latex of a first polymer and

(b) a second step of radical polymerization or copolymerization in microsuspension, in emulsion, in mini-emulsion or in suspension, in the presence of the latex of the first polymer obtained in the first step (a),

said method being characterized in that

either the first polymer forming the latex obtained in step (a) is a halogen-containing vinyl polymer and the polymer formed in step (b) is then an associative copolymer, preferably compatible with the halogen-containing vinyl polymer, containing both units from a first acrylic or vinyl monomer (A) and units from a second monomer (B) bearing at least one associative group,

or the polymer formed in step (b) is a halogen-containing vinyl polymer and the first polymer forming the latex obtained in step (a) is then an associative copolymer, preferably compatible with the halogen-containing vinyl polymer, containing both units from a first acrylic or vinyl monomer (A) and units from a second monomer (B) bearing at least one associative group.

The present invention also relates to a composite polymer latex or a polymer suspension prepared according to said method as well as a polymer composition obtained from said latex or from said suspension.

The method of the present invention thus makes it possible to obtain a polymer composition in which two polymers are intimately associated with one another. It offers the advantage of not requiring dissolution of these polymers in an organic solvent, and not requiring a stage of mixing and/or kneading of the polymers in the molten state.

Owing to the fact that the second polymerization step is applied in the presence of the latex obtained at the end of the first step of the method, the two polymers are associated with one another actually within the particles of latex, even when they are not compatible with one another.

There are classically four types of radical polymerization in a dispersed medium, namely

(i) suspension polymerization,

(ii) emulsion polymerization,

(iii) microsuspension polymerization,

(iv) mini-emulsion polymerization.

Suspension polymerization uses a free radical-generating initiator that is soluble in the monomer (dispersed phase) and the size of the polymer particles or grains obtained is relatively large, generally more than about 30 micrometers. The dispersion is generally stabilized with what are known as protective colloids, dispersing agents or suspending agents (cellulose ethers, partially hydrolyzed poly(vinyl acetate), poly(vinyl alcohol), gelatin, etc.). The particles are easily separated from the aqueous phase by centrifugation or filtration.

Emulsion polymerization uses radical initiators that are soluble in water (continuous phase). The droplets of monomers and particles of latex are stabilized with emulsifying agents, generally anionic or nonionic surfactants. The latex particles obtained are generally smaller than 1 micrometer. Because of this small size, these particles cannot be separated from the aqueous phase by centrifugation or filtration.

Microsuspension polymerization, like suspension polymerization, uses initiators that are soluble in the monomer (dispersed phase) but results in smaller particles, generally below 2 micrometers although sometimes up to 20 micrometers, and which cannot be separated from the aqueous continuous phase by simple centrifugation or filtration. To obtain small particles, it is necessary to carry out the polymerization in the presence of one or more surfactants and subject the reaction mixture beforehand to large shearing forces so as to preform droplets of monomers having a size corresponding to that of the particles that we wish to obtain.

Finally, mini-emulsion polymerization is similar to microsuspension polymerization in that it is necessary to prepare beforehand small droplets of monomer, where the polymerization takes place. The initiators are also generally soluble in the monomer phase, but can in certain cases be soluble in the continuous phase, and the final average particle size is generally between 0.2 and 1 micron.

In the method of the present invention, the applicant combines a first step of radical polymerization in emulsion, in microsuspension or in mini-emulsion, i.e. a first step which results in a latex with particles of small size, with a second step which is

either a stage of polymerization that also results in small particle sizes (emulsion/micro-suspension/mini-emulsion)

or a stage of suspension polymerization resulting in larger particle sizes.

In the first case, the final latex typically consists of particles having an average size, measured by laser granulometry in diffraction and diffusion (MASTERSIZER 2000® instrument from the company MALVERN) or using a sedimentometer, between 0.05 μm and 10 μm, preferably between 0.1 μm and 5 μm.

In the second case (combination of a stage of emulsion, microsuspension or mini-emulsion polymerization with a stage of suspension polymerization), the particles of the final latex typically have an average size between 30 μm and 250 μm.

As stated above, the vinyl polymer is polymerized by the radical mechanism during the first or second process step from suitable monomers or mixtures of comonomers.

We may mention, as examples of halogen-containing vinyl polymers, the chlorinated homopolymers or copolymers such as

poly(vinyl chloride) (PVC),

poly(vinylidene chloride),

copolymers of vinyl chloride and of at least one comonomer selected from acrylonitrile, ethylene, propylene and vinyl acetate, and

copolymers of vinylidene chloride and of at least one comonomer selected from vinyl chloride, acrylonitrile, acrylamide, methyl acrylate or methyl methacrylate,

as well as fluorinated homo- or copolymers comprising one or more monomers of formula (I):

CFX═CHX′ (I)

where X and X′ denote independently a hydrogen atom or halogen atom, in particular a fluorine or chlorine atom, or a perhalogenated, in particular perfluorinated, alkyl radical preferably with X═F and X′═H.

These fluorinated polymers are for example

poly(vinylidene fluoride) (PVDF),

copolymers of vinylidene fluoride with a halogenated comonomer preferably selected from hexafluoropropylene (HFP), chlorotrifluoroethylene (CTFE), hexafluoropropylene (HFP), trifluoroethylene (VF3) or tetrafluoroethylene (TFE),

homopolymers and copolymers of trifluoroethylene (VF3),

fluoroethylene/propylene copolymers (FEP),

copolymers of ethylene with fluoroethylene/propylene (FEP), tetrafluoroethylene (TFE), perfluoromethylvinyl ether (PFMVE), chlorotrifluoroethylene (CTFE) or hexafluoropropylene (HFP), and

mixtures thereof.

Among these halogen-containing vinyl polymers, poly(vinyl chloride) and poly(vinylidene fluoride) are particularly preferred because of their numerous interesting industrial applications.

In the case of copolymers of vinyl chloride, it is preferable for the proportion of vinyl chloride units to be greater than 25% and advantageously greater than 99% of the total weight of the copolymer.

As explained in the introduction, the halogen-containing vinyl polymer described above is associated, in the present invention, with a second polymer intended to improve the properties of the polymer compositions obtained, notably the mechanical properties.

The applicant found that modification of the properties of the halogen-containing vinyl polymer by the presence of the associative copolymer was particularly effective and durable when the two polymers were at least partially compatible with one another.

This compatibility, total or partial, can be demonstrated by various analytical methods known by a person skilled in the art such as scanning electron microscopy (SEM) or transmission electron microscopy (TEM) or atomic force microscopy (AFM), which permit the detection of inhomogeneities present within mixtures in the form of domains with characteristic size above 1 micron (immiscibility). It is considered, in the sense of the present invention, that the two polymers are compatible when the mixture is essentially free from such defects of homogeneity.

The homogeneity of a mixture can also be demonstrated by measuring the glass transition temperature (Tg), It is considered that a mixture of two polymers is completely homogeneous when it has a single glass transition temperature. The polymers are partially compatible when we can detect two or three glass transition temperatures, at least one of which is different from the Tg of the halogen-containing vinyl polymer and from the Tg of the associative copolymer. The methods for measuring the Tg of polymers and of mixtures of polymers are known by a person skilled in the art and include differential scanning calorimetry (DSC), volumetry or dynamic mechanical analysis (DMA).

Thus, copolymers bearing associative groups (=associative copolymer) and which are compatible, in the sense explained above, with the halogen-containing vinyl polymer, will preferably be used in the present invention.

The compatibility of the associative copolymer with the halogen-containing vinyl polymer is in principle provided by the comonomers (A), which are preferably selected from those whose corresponding homopolymers are compatible with the halogen-containing vinyl polymer.

As nonexclusive examples of acrylic or vinyl monomers (A), we may mention styrene and its derivatives, in particular styrene-4-sulfonate, acrylic acid, alkyl and hydroxyalkyl acrylates, sodium, potassium or ammonium acrylate, methacrylic acid, alkyl and hydroxyalkyl methacrylates, sodium, potassium or ammonium methacrylate, (methoxy)polyethylene-glycol (meth)acrylate, itaconic acid, vinyl acetate, maleic anhydride and acrylonitrile.

Among these, methyl methacrylate, (methoxy)polyethylene-glycol (meth)acrylate, acrylonitrile, maleic anhydride and mixtures of these monomers are particularly preferred, as they give copolymers that are compatible with the halogen-containing vinyl polymer.

In the method of the present invention, monomer (A) is copolymerized with at least one second monomer (monomer (B)) bearing at least one associative group.

“Associative groups” means, in the sense of the present invention, organic groups that can be associated with one another by multiple hydrogen bonds, advantageously by 2 to 6 hydrogen bonds.

They are preferably groups comprising an azotized heterocycle, preferably diazotized, with 5 or 6 ring members.

Examples of associative groups usable according to the invention are the imidazolidinyl, triazolyl, triazinyl, bis-ureyl, and ureido-pyrimidyl groups, the imidazolidinyl groups being preferred.

Ethylimidazolidone methacrylate and ethylimidazolidone methacrylamide may be mentioned as examples of monomers (B) for introducing imidazolidinyl groups.

The units obtained from monomer (A) preferably represent from 20 to 99 wt. % of the associative copolymer, in particular from 50 to 98% of the associative copolymer.

Finally, both the halogen-containing vinyl polymer and the associative copolymer can contain a small fraction of units from a comonomer having at least two unconjugated double bonds, polymerizable by radical polymerization. The copolymerization of said comonomers leads, as is known, to crosslinked polymers. We may mention, as examples of said comonomers, the divinyl diesters of polycarboxylic acids such as divinyl adipate, the diallyl esters of polycarboxylic acids such as diallyl phthalate and diallyl fumarate, the divinyl ethers of polyols such as the divinyl ether of ethylene glycol, aromatic divinyl compounds such as divinylbenzene, di- or triacrylates of monocarboxylic acids comprising an ethylenic unsaturation such as allyl methacrylate, the triallyl cyanurates, the di- or triacrylates of polyols such as ethylene glycol dimethacrylate, propylene glycol dimethacrylate, diethylene glycol diacrylate (DEGDA), diethylene glycol dimethacrylate (DEGDMA), glycerol triacrylate, trimethylolpropane triacrylate (TMPTA), trimethylolpropane trimethacrylate (TMPTMA), and the tetraacrylates of polyols such as pentaerythritol tetraacrylate.

This crosslinking comonomer is preferably used at a rate of 0.1 to 1 wt. %.

The four types of radical polymerization in a dispersed medium used in the present invention are known and described in general and specialized works, for example in Chapter 7 of the book “Les latex synthétiques: Elaboration, Propriétés, Applications” [Synthetic latices: Production, Properties, Applications], general editors C. Pichot and J. C. Daniel (Editions TEC&DOC de Lavoisier, France, 2006).

Regarding the combination of a first step of radical emulsion polymerization followed by a second step of suspension polymerization, reference may notably be made to patents U.S. Pat. No. 4,981,907 or U.S. Pat. No. 5,185,406.

Applications EP 0 647 663 and DE 101 21 580 describe examples of methods comprising two successive steps of emulsion polymerization.

As explained in the introduction, emulsion polymerization uses water-soluble initiators of radical polymerization. Various mechanisms for generating radicals can be employed, for example thermal decomposition, redox reactions, decomposition caused by electromagnetic radiation and, in particular, ultraviolet radiation. Nonexclusive examples of water-soluble initiators include hydroperoxides such as tert-butyl hydroperoxide, water-soluble azo compounds such as 2,2′-azobis-(2-amidinopropane)dihydrochloride and organic or mineral salts of 4,4′-azobis-(4-cyanovaleric) acid, mineral oxidizing agents such as sodium, potassium or ammonium persulfates, hydrogen peroxide, perchlorates, percarbonates and ferric salts. These oxidizing agents can be used alone or in combination with mineral or organic reducing agents such as bisulfite or metabisulfite of sodium or of potassium, vitamin C (ascorbic acid), sodium or potassium hypophosphites. These organic or mineral reducing agents can also be used alone, i.e. in the absence of mineral oxidizing agents. The initiators that are soluble in the aqueous phase are used at a rate of 0.01 to 10 wt. % relative to the total weight of the monomers.

In addition to the polymerization initiators, it may prove useful to dissolve other additives in the monomers that are to be copolymerized, and among these we may mention chain transfer agents, for lowering the molecular weights. As examples of chain transfer agents we may mention alkyl mercaptans, such as methylmercaptan, ethylmercaptan, n-propylmercaptan, isopropyl mercaptan, n-butylmercaptan, tert-butylmercaptan, cyclohexylmercaptan, benzylmercaptan, n-octyl-mercaptan, tert-nonylmercaptan, n-dodecyl-mercaptan, tert-dodecylmercaptan, alkyl thioglycolates such as methyl thioglycolate, ethyl thioglycolate, 2-ethyl-hexyl thioglycolate or iso-octyl thioglycolate. The chain transfer agents are generally used in proportions between 0.01 and 10%, and preferably between 0.5 and 2 wt. % relative to the total weight of the monomers.

It is also possible to dissolve, in the monomers that are to be copolymerized, other additives such as antioxidants, such as butylhydroxytoluene (BHT), biocides and/or activators of polymerization initiators. These additives are generally used in proportions between 0.01% and 5 wt. % relative to the total weight of the monomers.

Among surfactants usable as emulsifier and/or stabilizer, we may mention for example the following three families:
1) surfactant molecules of natural or synthetic origin having a dispersing and stabilizing effect by electrostatic repulsion and comprising positively or negatively charged amphiphilic molecules, or forming zwitterions (amphoteric), in an aqueous phase, among which we may mention, as nonexclusive examples: alkyl sulfates or sulfonates of sodium or potassium, in particular sodium dodecyl sulfate, alkaryl sulfates or sulfonates of sodium or potassium, in particular sodium dodecyl benzene sulfonate, the potassium, sodium or ammonium salts of fatty acids, in particular sodium stearate, alkylated and disulfonated diphenyl oxides, in particular commercial surfactants of the Dowfax® range, such as Dowfax® 2A1, sulfosuccinates and, in particular, commercial surfactants of the Aerosol® range such as Aerosol® MA 80, which is sodium dihexyl sulfosuccinate, or Aerosol® OT-75, which is sodium dioctyl sulfosuccinate, the phosphoric esters, fatty amines, polyamines and salts thereof, the quaternary ammonium salts, such as the ammonium alkyl trimethyl chlorides or bromides, betaines such as N-alkyl betaines or sulfobetaines, the imidazoline carboxylates, as well as the ethoxylated derivatives of all these compounds;
2) surfactant molecules having a dispersing and stabilizing effect by steric repulsion, uncharged or nonionic, among which we may mention, as nonexclusive examples: ethoxylated alkyl phenols, ethoxylated fatty alcohols, block copolymers of poly(ethylene oxide) and poly(propylene oxide), such as those from the Pluronic® range, esters of fatty acids, alkyl polyglycosides;
3) amphiphilic or hydrophilic polymer molecules, charged or uncharged, among which we may mention, as nonexclusive examples: water-soluble polymers of natural or synthetic origin such as polymers and copolymers of (meth)acrylic acid and salts thereof, polymers and copolymers of acrylamide and its derivatives, polymers based on vinyl alcohol and vinyl acetate, hydroxyethylcellulose and modified hydrophobic hydroxyethylcellulose, polyvinylcaprolactarn, and poly(vinylpyrrolidone).

These surfactants are generally present at a rate of 0.1 to 10 wt. % relative to the total weight of the monomers. It is also possible to carry out emulsion polymerization in the absence of surfactants or stabilizing or dispersing agents. In this case, the solids content of the latex obtained (determined by evaporation of the volatile compounds, in particular water) must however be less than 30 wt. %, relative to the total weight of the latex resulting from emulsion polymerization.

The emulsion polymerization of the associative copolymer can be carried out at atmospheric pressure or under pressure and at polymerization temperatures between 5° C. and 180° C. Preferably, the copolymer is obtained at atmospheric pressure and at polymerization temperatures between 50 and 95° C.

The emulsion or suspension polymerization of vinyl chloride or of its copolymers is carried out under pressure, typically between 5 and 15 bar, and at temperatures generally between 40 and 80° C.

Aqueous microsuspension or aqueous mini-emulsion polymerizations are known. A general description of these techniques is given for example in “Emulsion Polymerization and Emulsion Polymers”, Peter Lovell and Mohamed S. El Aasser, Publ. John Wiley & Sons.

Aqueous microsuspension polymerization can advantageously be effected in the presence of one or more populations of preformed latices, optionally containing polymerization initiators. This is then called “seeded” microsuspension polymerization. Patent applications FR 2 309 569 and FR 2 752 844 describe methods of microsuspension polymerization of poly(vinyl chloride) seeded with poly(vinyl chloride) latices. The latices obtained contain at least two populations of particles with different average diameter of the particles.

A person skilled in the art will have no particular difficulty in transferring the teachings of these documents, which relate more specifically to the polymerization of vinyl chloride, to the preparation of the associative (meth)acrylic copolymers of the present invention formed from monomers (A) and (B) described in detail above.

Radical suspension polymerization is also a technique that has been known for a long time. When it is employed, as in the present invention, in the presence of a latex prepared previously by emulsion polymerization, said latex is coagulated beforehand by adding an agent for precipitation of the emulsifier present in the latex (see U.S. Pat. No. 4,981,907 and U.S. Pat. No. 5,185,406). It is also possible to use, as suspending agent for stabilizing the suspension, a protective colloid, for example a poly(vinyl acetate), of which at least 50% of the acetate functions have been hydrolyzed.

Diacyl peroxides, peroxycarbonates, dialkyl peroxides and per-esters, such as those listed above, may also be mentioned as examples of radical initiators that are soluble in the monomer or comonomers to be polymerized.

The existence of two separate polymerization steps means that the respective proportions of the two types of polymers, i.e. the halogen-containing vinyl polymer and the associative copolymer, in the composite latex can be adjusted freely and quite precisely.

These proportions are within a very wide range, from 1 to 99.5 wt. % of halogen-containing vinyl polymer, relative to the total dry matter of the latex. The content of halogen-containing vinyl polymer in the latex and in the polymer composition of the present invention is preferably between 50 and 99 wt. %, especially preferably between 60 and 95 wt. %.

As mentioned previously, the present invention also relates to a polymer composition obtained from the composite latex or the polymer suspension of the present invention. This polymer composition can be obtained by various techniques of separation and treatment of the latex for removing the aqueous phase at least partially.

Examples of such techniques include spray drying, coagulation and lyophilization.

Spray drying consists of injecting the latex, generally by means of a spraying nozzle, into a stream of hot air. More precisely, the mixture is atomized using a conventional atomizer known by a person skilled in the art, such as a MINOR PRODUCTION® apparatus from the company NIRO. The air inlet temperature is preferably between 300 and 120° C. and the flow rate of the latex is selected so that the outlet temperatures of the air and of the atomized product are between 100° C. and 50° C.

Coagulation of the composite latices obtained at the end of a second step of emulsion, microsuspension or mini-emulsion polymerization is generally effected by mixing the latex, with sufficient stirring, with a coagulating agent based on a salt of a divalent or trivalent metal such as the chlorides, sulfates, nitrates or acetates of calcium, aluminum, iron, magnesium, strontium, barium, tin or zinc. Other types of coagulating agents can be used, such as monovalent salts such as sodium sulfate, ammonium carbonate, organic compounds such as methylisobutylcarbinol (described for example in patent application GB659722) or dioctyl phthalate (described for example in patent application JP7268021), or cationic or anionic polymers (described for example in patent application FR 2373564).

The suspensions obtained by a second step of suspension polymerization contain polymer particles or grains of sufficiently large size and that do not require a stage of atomization or coagulation. They can be drained, filtered and/or dried directly by the various technologies described in the prior art (see for example “Encyclopedia of PVC”, second edition, volume 1, director of publication Léonard I. Nass and Charles A. Heiberger, Marcel Dekker, Inc.).

The amount of coagulating agent used is usually between 100 and 50 000 ppm and preferably between 500 and 6000 ppm, relative to the amount of polymer or of copolymer. As well as the coagulating agent, a coagulation additive, such as a modified polyamine, can be added in order to facilitate filtration and to increase the proportion of solid matter in the coagulated product after filtration. Moreover, the pH of the medium can be adjusted to a value between 2 and 7 by adding a dilute acid, such as hydrochloric acid or sulfuric acid, to give a coagulate in the form of friable agglomerates, which are more easily filterable.

Coagulation of the latices can also be achieved by adding, with sufficient stirring, a strong mineral acid, such as hydrochloric acid or sulfuric acid, with or without supply of a coagulating agent as described above, the amounts of acid being fixed so as to obtain a pH close to 1. A method of the above type is described in patent application GB 1233144.

Other coagulation techniques can be used. These employ either heating of the latices with vigorous agitation by steam injection, with or without addition of a coagulating agent, as described in patent application DE954920, or special systems for agitation with very high mechanical shearing, such as turbine coagulators, which may or may not require the use of a coagulating agent (as described in patent application JP4106106), or freezing of the latex in a thin layer in a continuous process, as described in patent application FR2531716).

We thus obtain, after filtration and drying of the coagulated product, a pulverulent resin containing an intimate mixture of the halogen-containing vinyl polymer and of the copolymer bearing associative groups.

When this mixture is obtained by spray drying, it is generally a powder consisting of particles having an average diameter between 10 and 150 μm. When it is obtained by coagulation and then drying, it is generally a powder consisting of particles having an average diameter between 10 and 300 μm.

The granulometry of the powder is measured by diffraction and diffusion using for example a MASTERSIZER 2000® apparatus from the company MALVERN or by means of a sedimentometer with laser detection (BI-DCP apparatus from the company Brookhaven).

The composition according to the invention can moreover contain various additives including one or more plasticizers.

These can for example be selected from: polymeric plasticizers such as polyphthalates and polyadipates; monomeric plasticizers such as azelates, trimellitates (TOTM, TEHTM), sebacates (DIOS, DINS, DIDS), adipates (DOA, DEHA, DINA, DIPA), phthalates (DOP, DEHP, DIDP, DINP), citrates, benzoates, tallates, glutarates, fumarates, maleates, oleates, palmitates, acetates such as acetylated monoglycerides; and mixtures thereof. The phthalates such as dioctyl phthalate, dialkyl adipates such as di-tridecyl adipate (DTDA), di-acetylated monoglycerides such as glycerol monolaurate di-acetate and dialkyl sebacates such as diisodecyl sebacate (DIDS) are preferred for use in the present invention. The amount of plasticizer can for example represent from 60 to 100 wt. %, relative to the weight of the halogen-containing vinyl polymer.

The composition according to the invention can moreover contain:

lubricants, such as stearic acid and its esters (including Loxiol® G12 from COGNIS), waxy esters (including Loxiol G70 S from COGNIS), polyethylene waxes, paraffin or acrylic lubricants (including the Plastistrength® products, notably L1000, from ARKEMA),

mineral or organic pigments, such as carbon black or titanium dioxide,

thermal and/or UV stabilizers, such as stearates of tin, lead, zinc, cadmium, barium or sodium, including Thermolite® from ARKEMA,

co-stabilizers such as epoxidized natural oils, in particular epoxidized soya oils such as Ecepox® PB3 from ARKEMA,

antioxidants, for example phenolic, sulfur-containing or phosphite antioxidants,

fillers or reinforcing additives, notably cellulosic fillers, talc, calcium carbonate, mica or wollastonite, glass or metal oxides or hydrates,

antistatic agents,

fungicides and biocides,

antiimpact agents, such as MBS copolymers, including Clearstrength® C303H from ARKEMA, and acrylic modifiers of the core-shell type such as Durastrength® from ARKEMA,

swelling agents such as azodicarbonamides, azo-bis-isobutyronitrile, diethyl azo-bis-isobutyrate,

fireproofing agents, including antimony trioxide, zinc borate and brominated or chlorinated phosphate esters,

solvents, and

mixtures thereof.

These additives can for example represent from 0.1 to 50% of the total weight of the composition.

The polymer latex, the polymer suspension and the composition according to the invention can be used for the manufacture of materials that are either rigid, or plasticized. To do this, they can be applied by any means, and notably by calendering, extrusion, extrusion blow molding, injection molding, rotational molding, thermoforming, etc.

They can thus be used for the manufacture of coverings, notably floor and wall coverings, furniture coverings, grille components or interior parts of motor vehicles (such as fascia skins, steering wheels and door trim); clothing; seals, notably in the building industry or the automobile industry; self-adhesive, food-grade, agricultural films, in paper-making; roofing sheets and boards, as well as cladding boards; profiles, notably for showers and windows; shutters, doors, plinths, valleys; cables; and devices for transport or storage of fluids, in particular tubes, sleeves, pumps, valves or connectors; electric cabinets; hosepipes; bottles and flasks, sheet, notably for packaging; stretch films; bags for blood or solutions; transfusion tubes; records; toys; panels; helmets; shoes; hangings, curtains or tablecloths; buoys; gloves; blinds; fibers; glues and adhesives; membranes.

The invention therefore also relates to the aforementioned uses.

The invention will be better understood in light of the following examples, given for purposes of illustration only and not intended to limit the scope of the invention, which is defined by the appended claims.

### EXAMPLES

### Example 1

Method for Preparing a Composite Latex Comprising Two Steps of Radical Emulsion Polymerization

First Step:

Preparation of a Latex of Associative Copolymer by Radical Emulsion Copolymerization

A 30-liter autoclave equipped with a stirrer of the anchor type, a system for condensation of vapors under reflux and branch pipes for introducing the reactants, was charged with 10 liters of deionized water. Then 2.2 g of sodium formaldehyde sulfoxylate, 2.2 g of the disodium salt of ethylenediamine tetraacetic acid, 0.24 g of iron sulfate pentahydrate, 30 g of Murk acid and 8.5 g of potassium hydroxide are added. The autoclave is closed, the stirrer is switched on at 80 rev/min and the reaction mixture is purged by bubbling with nitrogen for 30 minutes. Then the following are added successively: 5.6 kg of methyl methacrylate, 0.48 kg of ethyl acrylate, 1.92 kg of Norsocryl N102 from Arkema (mixture of 25 wt. % of ethylimidazolidone methacrylate (MEIO) and 75 wt. % of methyl methacrylate) and 36.5 g of n-dodecylmercaptan from the company Arkema. Then the temperature of the reaction mixture is raised to 70° C. by heating the autoclave by means of its double jacket at a rate of 2° C./min. When the temperature reaches 70° C., an aqueous solution of potassium persulfate at 2 g/liter is injected at a flow rate of 200 ml/hour for 1 hour, then at 150 ml/hour for 3 hours. After 30 minutes at a temperature of 70° C., a solution of sodium laurylsulfate at 100 g/liter is injected at a flow rate of 250 ml/hour for 3.5 hours. After the potassium persulfate and sodium laurylsulfate have been added, reaction is completed by treatment for one hour at 80° C. with stirring, the autoclave is then cooled to 20° C. by injecting water at 18° C. into the double jacket. The total reaction time from the end of the heating ramp to the end of the treatment at 80° C. is about 5 hours. This gives 18.7 kg of latex at 38.4% of dry extract. The diameter of the individual particles, measured with the Brookhaven granulometer, comes to 132 nm.

Second Step:

Radical Emulsion Polymerization of Vinyl Chloride in the Presence of the Latex Obtained in the First Step

A 30-liter autoclave equipped with a stirrer of the anchor type is charged, at room temperature, with 4.6 kg of latex of associative copolymer (solids content 38.4 wt. %) obtained as described above. After adding 11.15 liters of deionized water, the pH of the medium is adjusted to a value between 9.5 and 10.5 by adding an aqueous solution of soda at 100 g/liter. 2.2 g of sodium formaldehyde sulfoxylate, 2.2 g of disodium salt of ethylenediamine tetraacetic acid and 0.24 g of iron sulfate pentahydrate are added. The autoclave is closed and the stirrer is switched on at 80 rev/min. A reduced pressure of 0.04 bar is applied for 30 minutes, then 8 kg of vinyl chloride is added. Stirring is continued for 60 minutes. Then the temperature of the reaction mixture is increased to 66° C. by heating the autoclave by means of its double jacket at a rate of 2° C./minute. When the temperature of 66° C. is reached, an aqueous solution of potassium persulfate (2 g/liter) is injected at a flow rate of 270 ml/hour for 1 hour, then at a flow rate of 180 ml/hour for 4 hours. The reaction is continued for a further 30 minutes at 66° C., then an aqueous solution of sodium laurylsulfate (80 g/Iiter) is injected at a flow rate of 250 ml/hour for 4 hours. The reaction is continued until the pressure has decreased by 1 bar relative to the initial pressure. Then the reaction mixture is cooled to a temperature of 50° C. by circulating water at 18° C. in the double jacket. The total reaction time from the end of the temperature rise until the pressure drops by 1 bar is about 5 hours. At 50° C., the reaction mixture is then degassed by aspiration of the vinyl chloride under reduced pressure, then the autoclave is placed under dynamic vacuum for 4 hours to remove the residual vinyl chloride. This gives 22.6 kg of latex having a solids content of 39.6%. The average particle diameter, measured with the Brookhaven granulometer, is 168 nm.

### Example 2

Method for Preparing a Composite Latex Comprising Two Steps of Radical Emulsion Polymerization

First Step:

Synthesis of a PVC Latex by Radical Emulsion Polymerization

A 30-liter autoclave equipped with a stirrer of the anchor type is charged with 8.8 liters of deionized water, 32 g of lauric acid and 9 g of potassium hydroxide in the form of an aqueous solution (100 g/liter). 1.1 g of sodium formaldehyde sulfoxylate, 1 g of the disodium salt of ethylenediamine tetraacetic acid and 0.11 g of iron sulfate pentahydrate are added. The autoclave is closed, the stirrer is switched on at 80 rev/min, and a reduced pressure of 0.04 bar is applied for 30 minutes. Then 8 kg of vinyl chloride is added. The temperature is increased at a rate of 2° C./minute up to a value of 55° C. When the temperature reaches 55° C., a solution of ammonium persulfate in water (4 g/liter) is injected at a flow rate of 200 ml/hour for 5 hours. The reaction is continued for a further 30 minutes at a temperature of 55° C., then a solution of sodium dodecylbenzenesulfonate (88 g/liter) is injected at a flow rate of 250 ml/hour for 4 hours. The reaction is continued 2 0 until the pressure has dropped by 1 bar relative to the initial pressure. Then the autoclave is cooled to 40° C. by circulating water at 18° C. in the double jacket. The total reaction time from the end of the temperature rise until the pressure drops by 1 bar is about 5 hours. At 40° C., at a reduced stirring speed (50 rev/min), the vinyl chloride is removed by aspiration and then the autoclave is placed under dynamic vacuum for 4 hours to remove the residual vinyl chloride. This gives 18 kg of latex at 39.3% of dry extract. The average particle diameter, measured using a Brookhaven granulometer, is 115 nm.

Second Step:

Emulsion Polymerization of an Associative Copolymer in the Presence of the Latex Prepared in the First Step

A 30-liter autoclave equipped with a stirrer of the anchor type, a system for condensation of vapors under reflux and branch pipes for introducing the reactants, is charged with 4.6 kg of the PVC latex (solids content 39.3 wt. %) obtained as described above and 11.5 liters of deionized water. 2.2 g of sodium formaldehyde sulfoxylate, 2.2 g of disodium salt of ethylenediamine tetraacetic acid and 0.24 g of iron sulfate are added. The autoclave is closed, the stirrer is switched on at 80 rev/min and the reaction mixture is purged by bubbling with nitrogen for 30 minutes. Then the following are added successively: 5.6 kg of methyl methacrylate, 0.48 kg of ethyl acrylate, 1.92 kg of Norsocryl N102 from Arkema (mixture of 25 wt. % of ethylimidazolidone methacrylate (MEIO) and 75 wt. % of methyl methacrylate) and 36.5 g of n-dodecylmercaptan from Arkema. Then the temperature of the reaction mixture is raised to 70° C. by heating the autoclave by means of its double jacket at a heating rate of 2° C./min. When the temperature reaches 70° C., an aqueous solution of potassium persulfate at 2 g/liter is injected at a flow rate of 200 ml/hour for 1 hour, then at 150 ml/hour for 3 hours. After 30 minutes at a temperature of 70° C., a solution of sodium laurylsulfate at 100 g/liter is injected at a flow rate of 250 ml/hour for 3.5 hours. After the potassium persulfate and sodium laurylsulfate have been added, the reaction is completed by treatment for one hour at 80° C. with stirring; the autoclave is then cooled to 20° C. by injecting water at 18° C. into the double jacket. The total reaction time from the end of the heating phase up to the end of treatment at 80° C. is about 5 hours. This gives 25.4 kg of latex at 34.3% of dry extract. The diameter of the individual particles, measured with the Brookhaven granulometer, comes to 155 nm.

Example 3

Method for Preparing a Composite Latex Comprising a First Step of Radical Emulsion Polymerization and a Second Step of Radical Suspension Polymerization

First Step:

Preparation of a Latex of Associative Copolymer by Radical Emulsion Copolymerization

A latex of associative copolymer having a dry extract of 38.4% and an average particle diameter of 132 nm is prepared in the manner described in the first step of Example 1.

Second Step:

Preparation of a Composite Latex by Suspension Polymerization of Vinyl Chloride in the Presence of a Latex of Associative Copolymer

A 30-liter autoclave, equipped with a stirrer of the three-vane screw type, also called “impeller”, was charged at room temperature with 5 kg of the latex of associative copolymer from the first step having a dry extract of 38.6%. 12 kg of deionized water is added. Then 5.4 g of di(2-ethylhexyl) carbonate is incorporated in the form of a solution at 75 wt. % in isododecane. The autoclave is closed, the stirrer is switched on at 350 rev/min and a reduced pressure of 0.04 bar is applied for 5 minutes. Then 100 g of CaCl₂, previously dissolved in 1 liter of water, is injected. Stirring is continued for 30 minutes, then 2 kg of water is injected, in which 3.7 g of a colloid of the poly(vinyl acetate) type hydrolyzed to a proportion of hydroxyl groups of 88 mol. %, 3.7 g of a colloid of the poly(vinyl acetate) type hydrolyzed to a proportion of hydroxyl groups of 72 mol. % and 31 g of a colloid of the poly(vinyl acetate) type hydrolyzed to a proportion of hydroxyl groups of 55 mol. % have been dissolved. A reduced pressure of 0.04 bar is applied again for 30 minutes. Then 9 kg of vinyl chloride is added. Stirring is continued at room temperature for 60 minutes, then the reaction mixture is heated to a temperature of 56.5° C. at a rate of 2° C./minute. Then the reaction is continued at this temperature until a pressure drop of 1 bar is reached, relative to the initial pressure. The autoclave is cooled to a temperature of 30° C. by circulating water at 18° C. in the double jacket of the autoclave. The total reaction time, from the end of the temperature rise until the pressure drops by 1 bar, is about 4 hours, At 30° C., with moderate stirring of 100 rev/min, the vinyl chloride is removed by reduced pressure, then the autoclave is placed under dynamic vacuum for 4 hours to remove the residual vinyl chloride. This gives 27.6 kg of a suspension containing 9.55 kg of polymer (dry extract). The average particle diameter, measured using a MALVERN granulometer, is 160 micrometers.

### Example 4

Method for Preparing a Composite Latex Comprising a First Step of Radical Emulsion Polymerization and a Second Step of Radical Suspension Polymerization

First Step

Synthesis of a PVC Latex by Radical Emulsion Polymerization

A latex of polyvinyl chloride is prepared as described in the first step of Example 2, having a dry extract of 39.3% and an average particle diameter, measured using a Brookhaven granulometer, of 115 nm.

Second Step

Preparation of a Composite Latex by Radical Suspension Copolymerization in the Presence of the PVC Latex from the First Step

A 30-liter autoclave, equipped with a stirrer of the three-vane screw type, also called “impeller”, is charged, at room temperature, with 5 kg of the PVC latex from the first step having a dry extract of 39.3%. 14 kg of deionized water is added. Then 5.4 g of di(2-ethylhexyl) percarbonate in the form of a solution at 75 wt. % in isododecane is incorporated. The autoclave is closed and the stirrer is switched on at 350 rev/min, Then 100 g of CaCl₂, previously dissolved in 1 liter of water, is injected. Stirring is continued for 30 minutes, then 2 kg of water, in which 3.7 g of a colloid of the poly(vinyl acetate) type hydrolyzed to a proportion of hydroxyl groups of 88 mol. % and 3.7 g of a colloid of the poly(vinyl acetate) type hydrolyzed to a proportion of hydroxyl groups of 72 mol. % were dissolved beforehand, is injected. Then the mixture is purged by bubbling with nitrogen for 30 minutes, then the following are introduced successively: 6.3 kg of methyl methacrylate, 0.54 kg of ethyl acrylate, 2.16 kg of Norsocryl N102 from the company Arkema (mixture of 25 wt. % of ethylimidazolidone methacrylate (MEIO), and of 75 wt. % of methyl methacrylate) and 36.5 g of n-dodecylmercaptan from the company Arkema. Stirring is continued at room temperature for 60 minutes, then the reaction mixture is heated to a temperature of 60° C. at a rate of 2° C./minute. Then the reaction is continued at this temperature for 4 hours with an additional stage of 30 minutes at 70° C. Then the autoclave is cooled to a temperature of 20° C. by circulating water at 18° C. in the double jacket of the autoclave. This gives 30.7 kg of a suspension containing 9.95 kg of polymer (dry extract). The average particle diameter, measured using a MALVERN granulometer, is 172 micrometers.

1. A method for preparing a latex comprising
(a) a first step of forming a latex of a first polymer by radical polymerization or copolymerization in emulsion, in microsuspension or in mini-emulsion, and
(b) a second step of forming a second polymer by radical polymerization or copolymerization in emulsion, in microsuspension, in mini-emulsion or in suspension, in the presence of the latex of the first polymer obtained in the first step (a), wherein
either the first polymer obtained in step (a) is a halogen-containing vinyl polymer and the polymer formed in step (b) is an associative copolymer containing both units from a first acrylic or vinyl monomer (A) and units from a second monomer (B) bearing at least one associative group,
or the polymer formed in step (b) is a halogen-containing vinyl polymer and the first polymer forming the latex obtained in step (a) is an associative copolymer containing both units from a first acrylic or vinyl monomer (A) and units from a second monomer (B) bearing at least one associative group.

2. The method as claimed in claim 1, wherein the halogen-containing vinyl polymer is selected from
poly(vinyl chloride) (PVC),
poly(vinylidene chloride),
copolymers of vinyl chloride and of at least one comonomer selected from acrylonitrile, ethylene, propylene and vinyl acetate,
copolymers of vinylidene chloride and of at least one comonomer selected from vinyl chloride, acrylonitrile, acrylamide, methyl acrylate or methyl methacrylate,
fluorinated polymers comprising one or more monomers of formula (I):
CFX═CHX′ (I)
where X and X′ denote independently a hydrogen atom or halogen atom, in particular a fluorine or chlorine atom, or a perhalogenated, in particular perfluorinated, alkyl radical preferably with X═F and X′═H.

3. The method as claimed in claim 2, wherein the halogen-containing vinyl polymer is poly(vinyl chloride).

4. The method as claimed in claim 2, wherein the fluorinated vinyl polymer is selected from:
poly(vinylidene fluoride) (PVDF),
copolymers of vinylidene fluoride with one or more halogenated comonomer,
homopolymers and copolymers of trifluoroethylene (VF3),
fluoroethylene/propylene copolymers (FEP),
copolymers of ethylene with fluoroethylene/propylene (FEP), tetrafluoroethylene (TFE), perfluoromethylvinyl ether (PFMVE), chlorotrifluoroethylene (CTFE) or hexafluoropropylene (HFP), and
mixtures thereof.

5. The method as claimed in claim 1, wherein monomer (A) is selected from styrene and its derivatives; acrylic acid; alkyl and hydroxyalkyl acrylates; sodium, potassium or ammonium acrylate; methacrylic acid; alkyl and hydroxyalkyl methacrylates; sodium, potassium or ammonium methacrylate; (methoxy)polyethylene-glycol (meth)acrylate; itaconic acid; vinyl acetate; maleic anhydride and acrylonitrile.

6. The method as claimed in claim 5, wherein monomer (A) is selected from the group comprising methyl methacrylate, (methoxy)polyethylene-glycol (meth)acrylate, acrylonitrile, maleic anhydride and mixtures thereof.

7. The method as claimed in claim 1, wherein the units from monomer (A) represent from 20 to 99 wt. % of the associative copolymer.

8. The method as claimed in claim 1, wherein the associative group or groups of monomer (B) are selected from imidazolidinyl, triazolyl, triazinyl, bis-ureyl and ureido-pyrimidyl groups.

9. The method as claimed in claim 1, wherein monomer (B) is ethylimidazolidone methacrylate or ethylimidazolidone methacrylamide.

10. The method as claimed in claim 1, wherein the halogen-containing vinyl polymer and/or the associative copolymer further comprise units from a comonomer having at least two unconjugated double bonds, polymerizable by radical polymerization.

11. A latex or polymer suspension obtained by the method as claimed in claim 1.

12. The latex or polymer suspension as claimed in claim 11, wherein the fraction of halogen-containing vinyl polymer, relative to the total dry matter of the latex, is between 1 and 99.5 wt. %.

13. (canceled)

14. The latex or polymer suspension as claimed in claim 11 comprising one or more articles or processes selected from the group consisting of making coverings, floor and wall coverings, furniture coverings, grille components, interior parts of motor vehicles, (fascia skins, steering wheels, door trim); clothing; seals; self-adhesive, food-grade, agricultural films; in paper-making; roofing sheets and boards, cladding boards; profiles, for showers and windows; shutters, doors, plinths, valleys; cables; devices for transport or storage of fluids, tubes, sleeves, pumps, valves, connectors; electric cabinets; hosepipes; bottles and flasks, sheet, packaging sheet; stretch films; bags for blood or solutions; transfusion tubes; records; toys; panels; helmets; shoes; hangings, curtains, tablecloths; buoys; gloves; blinds; fibers; glues, adhesives; and membranes.

15. The method of claim 1, wherein the associative copolymer is compatible with the halogen-containing vinyl polymer.

16. The method of claim 4, wherein in said copolymers of vinylidene fluoride with one or more halogenated comonomer, the halogentated comonomer is selected from hexafluoropropylene (HFP), chlorotrifluoroethylene (CTFE), hexafluoropropylene (HFP), trifluoroethylene (VF3) or tetrafluoroethylene (TFE).

17. The method of claim 5, wherein the styrene derivatives is styrene-4-sulfonate.

18. The method of claim 8, wherein the associative group or groups of monomer (B) are imidazolidinyl.

19. The latex or polymer suspension as claimed in claim 12, wherein the fraction of halogen-containing vinyl polymer, relative to the total dry matter of the latex, is between 50 and 99 wt. %.
